(19) United States
(12) Patent Application Publication
(10) Pub. No.: US 2020/0084045 A1
(43) Pub. Date: Mar. 12, 2020

(54) ESTABLISHING PROVENANCE OF DIGITAL ASSETS USING BLOCKCHAIN SYSTEM

(71) Applicant: MasterPeace Solutions Ltd., Columbia, MD (US)

(72) Inventors: Andrew Cohen, Fulton, MD (US); Ryan Patrick Kirby, Severna Park, MD (US); Michael Harold Kolodny, Gambrills, MD (US)

(21) Appl. No.: 16/566,812

(22) Filed: Sep. 10, 2019

Related U.S. Application Data
(60) Provisional application No. 62/729,330, filed on Sep. 10, 2018.

(51) Int. Cl. H04L 9/32; H04L 9/06

(52) U.S. Cl. CPC H04L 9/3247; H04L 9/0643; H04L 2209/56; H04L 2209/38; H04L 9/0637

(57) ABSTRACT

In some implementations, a method is provided. The method includes receiving a request to establish a provenance of a digital asset. The digital asset includes a set of signatures. The method also includes generating a hash of the digital asset. The method further includes updating a distributed ledger of a blockchain system with the hash of the digital asset to establish the provenance of the digital asset.

### CROSS-REFERENCE TO RELATED APPLICATIONS

This application claims the benefit of U.S. Provisional Patent Application No. 62/729,330, filed on Sep. 10, 2018. The disclosure of the above-referenced application is hereby incorporated by reference in its entirety.

### TECHNICAL FIELD

Aspects of the present disclosure relate to digital assets, and more particularly, to establishing the provenance of digital assets using a block chain system.

### BACKGROUND

Digital assets are commonly used, viewed, consumed, played, heard, etc., by users of computing devices. Digital assets may include items such as documents (e.g., documents in digital format or stored as a file), digital images, digital movies, digital music, audio clips, video clips, streaming media, pod casts, emails, web forum posts/threads, web pages, social media posts, chat messages, etc. These digital assets are often created and/or modified by various users and/or entities (e.g., different companies, organizations, etc.).

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram that illustrates an example system architecture, in accordance with some embodiments of the present disclosure.

FIG. 2 is a block diagram that illustrates an example asset verification component, in accordance with some embodiments of the present disclosure.

FIG. 3 is a block diagram that illustrates an example entry in a ledger, in accordance with some embodiments of the present disclosure.

FIG. 4 is a flow diagram for establishing the provenance of a digital asset, in accordance with some embodiments of the present disclosure.

FIG. 5 is a sequence diagram illustrating example actions for signing a digital asset, in accordance with one or more embodiments of the present disclosure.

FIG. 6 is a sequence diagram illustrating example actions for signing a digital asset, in accordance with one or more embodiments of the present disclosure.

FIG. 7 is a block diagram of an example computing device that may perform one or more of the operations described herein, in accordance with some embodiments of the present disclosure.

### DETAILED DESCRIPTION

Digital assets are often created and/or modified by various users, entities (e.g., different companies, organizations, etc.). Because the digital assets can be created and/or modified by various users, entities, etc., it may be useful to be able to establish the provenance and/or integrity of the digital assets and/or other data. This allows users who consume, view, use, read, etc., the digital assets to verify the identity of the users or entities that created and/or modified the digital assets. For example, this may allow a user to verify that an article (e.g., a news article) was published by a particular entity (e.g., by a particular news organization). In another example, this may also allow users to verify that they are view, consuming, reading, etc., a legitimate version of the digital asset. In a further example, this may provide proof that users who have signed a digital asset have authorized the digital asset, approved of the content of the digital asset, and/or agreed to the content of the digital asset.

However, it may be difficult to verify the provenance of a digital asset. The present disclosure addresses the above-noted and other deficiencies by using a blockchain system. The blockchain system may include a ledger that is distributed across all of the nodes in the blockchain system (e.g., a distributed ledger). An asset verification component may use the block chain system to store data related to the creation and/or modification of the digital assets. This may allow the asset verification component to establish the provenance (e.g., integrity) of digital assets and/or other data which may be managed by the asset verification component. The digital assets may be referenced and/or accessed (e.g., viewed, consumed, used, played, etc.) by users through a universal resource locator (URL) and/or may be stored in a storage system (e.g., an encrypted data storage device, an encrypted database, etc.).

Users of the asset verification component may be allowed to create digital assets and/or add digital assets to the asset verification component. The users of the asset verification component may also be able sign the digital assets which allows for future verification of the digital assets. For example, when a user signs the document, this may provide proof that the user created, updated, agreed to, and/or approved of the content of a digital asset. A hash of the digital asset (e.g., a cryptographic hash) may also be created to help ensure the integrity of the digital asset (e.g., to allow other users to verify that they are viewing the correct digital asset or a correct version of the digital asset, and not a modified version of the digital asset which may have been modified by a malicious user).

The asset verification component may allow registered users (e.g., users who have registered an account with the asset verification component) and non-registered users. Non-registered users may provide data, documents, etc., with a strong proof of identity to the asset verification component. For example, a non-registered user who wishes to sign, publish, create, modify, etc., a digital asset may provide strong proof of identity in a process similar to the process of obtaining a passport. Registered users may be issued hardware tokens (or software tokens) that allow the registered users to create unique digital signatures. The registered users may also use a different two-factor authentication system. For example, the registered users may be employees of a company and may use the company's existing two-factor authentication system. When a user publishes, creates, stores, etc., a digital asset in the asset verification component, a hash (e.g., a cryptographic hash) of the digital asset is created and the digital asset is signed with the token and/or one or more keys (e.g., a private key of a private/public key pair). The signature establishes proof that the user published the document and the hash helps to ensure the integrity of the document (e.g., allows other users to determine if the document has been modified or tampered with). The hashes and/or public keys may be added to blocks in the ledger (e.g., a distributed ledger) of a blockchain system. The distributed nature of the blockchain system (e.g., a peer-to-peer network) helps to prevent malicious users from modifying the hashes and/or public keys.

In one embodiment, the tokens (e.g., hardware or software token generators) may be used to sign a digital asset. Thus, the tokens may be used to both access the system architecture but may also be used to sign the asset to establish the provenance and/or integrity of the digital asset. For example, the token may be used in conjunction with a private key of a user to sign a digital asset. This may bind the token and the proof of identify of the signer, to the digital asset. In one embodiment, a token may be a software token such as an application (e.g., an app) on a smartphone or tablet computer (e.g., a client device). The token (e.g., a hardware token, a software token, an app on a smartphone/tablet computer, etc.) may be referred to as a signing component.

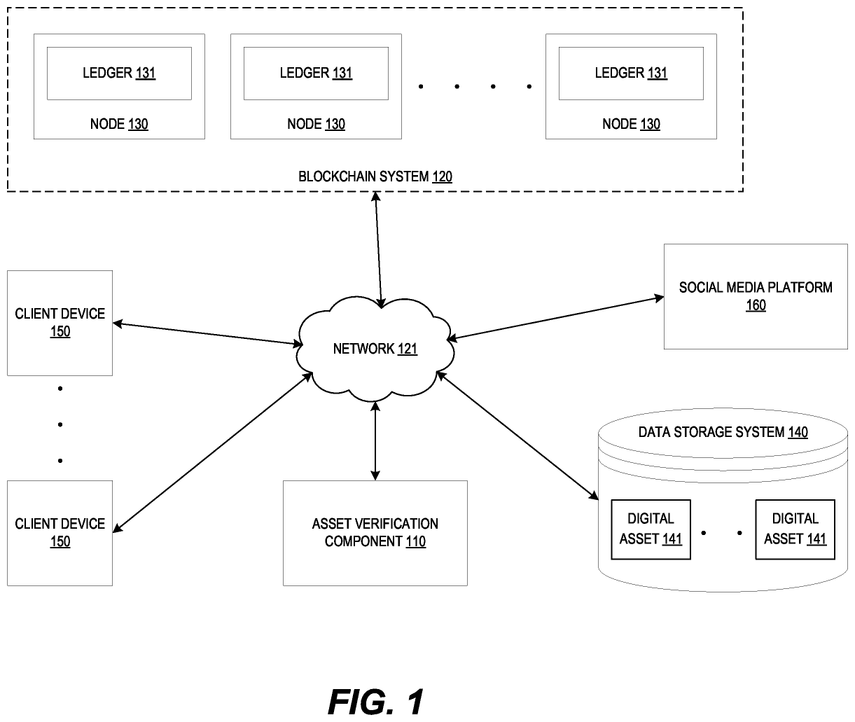

FIG. 1 is a block diagram that illustrates an example system architecture 100, in accordance with some embodiments of the present disclosure. As illustrated in FIG. 1, the system architecture 100 includes a network 121, a blockchain system 120, an asset verification component 110, a data storage system 140, a social media platform 160, and client devices 150. As discussed above, the asset verification component 110 may help to establish the provenance and/or integrity of digital assets 141 and/or other data. For example, the asset verification component 110 may help users verify the content of a digital asset 141, verify the authors of a digital asset 141, verify one or more parties (e.g., users or entities) that have signed a digital asset 141 (e.g., that have agreed to the content of a digital asset 141, etc.).

In one embodiment, the blockchain system 120 may be a system that uses a ledger 131 to record transactions. The ledger 131 includes a plurality of blocks which are linked together and are secured using cryptographic functions. For example, each block may include a cryptographic hash of the previous block, a timestamp, and other data (e.g., a hash of a document, public keys, etc., as discussed in more detail below). The blockchain system 120 includes a set of nodes 130 (e.g., one or more nodes 130, a plurality of nodes 130, etc.) coupled to each other via a network 121.

Network 121 may be a public network (e.g., the internet), a private network (e.g., a local area network (LAN) or wide area network (WAN)), or a combination thereof. In one embodiment, network 121 may include a wired or a wireless infrastructure, which may be provided by one or more wireless communications systems, such as a wireless fidelity (WiFi) hotspot connected with the network 121 and/or a wireless carrier system that can be implemented using various data processing equipment, communication towers (e.g. cell towers), etc. The network 121 may carry communications (e.g., data, message, packets, frames, etc.) between the blockchain system 120, the client devices 150, the asset verification component 110, the data storage system 140, and/or the social media platform 160.

A node 130 may be a combination of one or more computing devices. A computing device may be any suitable type of computing device or machine that has a programmable processor including, for example, server computers, desktop computers, laptop computers, tablet computers, smartphones, set-top boxes, etc. In some examples, a computing device may comprise a single machine or may include multiple interconnected machines (e.g., multiple servers configured in a cluster). A node 130 may also be one or more virtual environments, such as virtual machines, containers, etc.

Each node 130 includes a ledger 131. The ledger 131 may also be referred to as distributed ledger. A distributed ledger may be a ledger where copies of the ledger are distributed across multiple nodes (e.g., across multiple computing devices). In one embodiment, a ledger 131 may include multiple entries (e.g., blocks). Each of the entries may include data that may be used for to verify digital assets that are managed by the asset verification component 110. For example, the blocks may include digital signatures, hashes of digital assets, public keys, digital certificates, etc. Each ledger 131 may be stored in a data store (not illustrated in the figures) of a respective node 130. The data store may be a persistent storage. A persistent storage may be one or more devices that are capable of storing data. A persistent storage may be a local storage unit or a remote storage unit. Persistent storage may be a magnetic storage unit, optical storage unit, solid state storage unit, electronic storage units (main memory, cache, random access memory (RAM)), or similar storage unit. Persistent storage may also be a monolithic/single device or a distributed set of devices. The distributed nature of the ledger 131 allows for more security against loss, more security against hacking, etc.

In one embodiment, the blockchain system 120 may be an existing blockchain system. For example, the blockchain system may be the blockchain system that is associated with or is used to store and/or identify transactions for a cryptocurrency. For example, the blockchain system 120 may be used by a cryptocurrency such as Bitcoin and Ethereum. Using an existing blockchain system may allow the system architecture 100 to provide better security and protection against malicious users and/or attacks. For example, cryptocurrencies often use blockchain systems with a larger (e.g., hundreds, thousands, millions, etc.) of nodes. The distribution of the ledger 131 across all of the nodes 130 prevents the ledger 131 that is stored on the nodes 130 from being maliciously modified and/or hacked and provides more security against malicious users. For example, the distributed nature of a ledger 131 may make it more difficult to compromise the information in the ledger 131. In another example, the majority voting system of the blockchain system 120 may also make it more difficult to compromise the information in the ledger 131.

In one embodiment, the digital assets 141 may include social media posts that are part of the social media platform 160. For example, a user may post a comment to the user's friends or followers on the social media platform 160. The comment, post, etc., may be thought of as a document. The asset verification component 110 may be used to establish the provenance of the social media post. For example, the asset verification component 110 may be used to establish that a particular user posted the comment. In another example, the asset verification component may be used to establish that the content of the post (e.g., the text, images, videos, etc.) were as the user originally posted and have not been modified or tampered with.

In one embodiment, the asset verification component 110 may manage digital assets 141 that include public documents. For example, public legal documents such as contracts, deeds, land titles, and/or other land records may be managed and/or stored by the asset verification component 110. The content of these digital assets 141 (e.g., the deed, title, contract, etc.) may be available to the general public. For example, any user may be able to view a land title. In addition, the identity of the signers of the public documents may also be available to the general documents. For example, any users may be able to determine the identity (e.g., a legal name) of the people and/or entities who have signed a contract. The public documents may be stored on the data storage system 140.

The public documents may be signed by multiple users, entities, etc. The digital signatures help to establish the integrity of the public document and may also provide proof of the identity of the signer(s). This may allow the asset verification component 110 to provide functions and/or verifications similar to a notary public. The digital signatures, hashes of digital assets, and/or public keys of users who signed the public documents may be stored within the blocks of the ledger 131 which is distributed among the nodes 130. The public documents (e.g., digital assets 141) may be searched using various parameters such as the identity of the signer (e.g., legal name), content of the document, and/or other attributes.

In one embodiment, the asset verification component 110 may store the digital assets 141 in the data storage system 140 and may provide an externally accessible URL to allow the general public to access the digital assets 141 (e.g., to access an online news article). The externally accessible digital assets 141 may not be modified because modification of the digital assets 141 may cause the hashes of the digital assets 141 to change which may indicate that the integrity and/or authenticity of the documents may be compromised. The asset verification component 110 may provide two links (e.g., two URLs) for each digital asset 141. The first link may allow users to access the digital asset 141 (e.g., to view the news article, to watch a news clip, etc.). The second link may provide the user with details about the author of the digital asset 141 and the integrity of the digital asset 141.

In another embodiment, the asset verification component 110 may manage digital assets 141 for an entity, such as a company, corporation, enterprise, business, organization, etc. For example, the asset verification component 110 may be used for enterprise records management for a company. The entity (e.g., the company or enterprise) may be responsible for verifying the identity of the users that may create, store, update, etc., digital assets on behalf of the entity (e.g., verifying the identity of the employees that may create digital assets). The entity may integrate the entity's own authentication systems and/or policies with the asset verification component 110. For example, the entity may use a two-factor (or multi-factor) authentication system and the asset verification component 110 may be able to interact with the two-factor (or multi-factor) authentication system of the entity. The asset verification component 110 may also provide a different two-factor (or multi-factor) authentication system for the entity to use.

The digital assets 141 for the entity may not be publicly available to the general public unless the entity allows the digital assets 141 to be publicly available. For example, the digital asset 141 may be a press release and the entity may allow the press release to be publicly accessible. In another example, the digital asset 141 may be an internal document/memo (e.g., a product specification/design document) and the entity may not allow users outside of the entity (e.g., non-employees) to access the internal document/memo.

In one embodiment, the asset verification component 110 may receive a request to establish the provenance of a digital asset 141 (e.g., a document, an email, a form posting, a chat message, a social media post, etc.). For example, a user may provide or send the digital asset 141 (or a copy of the digital asset 141) to the asset verification component 110. The user may request that the asset verification component 110 establish the provenance of the digital asset 141. The provenance of the digital asset 141 may allow other uses of the system architecture 100 to verify the content of the digital asset 141. For example, signatures (e.g., digital and/or electronic signatures) help to establish the integrity of the public document and may also provide proof of the identity of the signers. The hashes of the digital assets may also help assure other users that a digital asset 141 has not been modified from the version that was provided to the asset verification component 110. In another example, the provenance of the digital asset 141 may allow other users of the system architecture 100 to verify that that the digital asset 141 was generated by one or more users (e.g., that one or more users were authors of the digital asset 141 or approved the digital asset 141). In a further example, the provenance of the digital asset 141 may allow a user to verify that the digital asset 141 is a specific version or draft of the digital asset 141. Establishing the provenance of the digital asset 141 may allow other users to trust that the content of a digital asset 141 has not been tampered with. Establishing the provenance of the digital asset 141 may also allow other users to trust that certain users have authored, approved, and/or agreed to the content of a digital asset.

The asset verification component 110 may receive the digital asset 141 and may store the digital asset 141 within the system architecture 100. In one embodiment, the asset verification component 110 may store the digital asset 141 (that are managed by the asset verification component 110) in a data storage system 140. The data storage system 140 may include one or more devices and/or persistent storage that are capable of storing data. A persistent storage may be a local storage unit or a remote storage unit. Persistent storage may be a magnetic storage unit, optical storage unit, solid state storage unit, electronic storage units (main memory, cache, random access memory (RAM)), or similar storage unit. Persistent storage may also be a monolithic/single device or a distributed set of devices. The data storage system 140 may be a data store that is separate from the ledger 131 (e.g., separate from the data stores of the nodes 130 that are used to store the ledger 131).

In other embodiments, the digital asset 141 may be stored as part of the ledger 131. For example, the digital assets 141 may be included as part of the entries of the ledger 131. As discussed, the distributed nature of the ledger 131 may help protect the digital assets 141 from being modified by a malicious user and the tokens, signature, hashes, keys, etc., may help establish the provenance and/or integrity of the digital assets.

In one embodiment, the digital asset 141 may optionally include a set of signatures (e.g., one or more signatures). For example, one or more client devices 150 may generate signatures which may be added (e.g., appended to) to the digital asset 141. Each signature may be generated by user of a client device 150. The signature may also help establish the provenance of the digital asset 141. For example, the signature may help establish or prove that a particular user (e.g., the user who signed the digital asset 141) was the author of the digital asset or is associated with the digital asset 141 in some way (e.g., approved the content of the digital assets, agrees to the terms of an agreement, etc.). In some embodiments, the signatures included in the digital asset 141 may be referred to as electronic signatures. An electronic signature may be data (e.g., an image of a user's signature, text, other data, etc.) that may be used to indicate and/or represent the signature of a user (e.g., the handwritten signature of a user). An electronic signature may be generated using the private key of the user. A digital asset 141 may optionally include one or more electronic signatures.

In one embodiment, the asset verification component 110 may generate a hash of a digital asset 141 (which may include one or more signatures, such as electronic signatures). The hash may be generated using various hash/hashing functions, hash/hashing algorithms, hash/hashing operations, etc. For example, the hash may be generated by applying a cryptographic hashing function (e.g., secure hash algorithm 256 (SHA-256), message digest algorithm 6 (MD6) to the digital asset 141. In another example, a hash may be generated by applying a hashing function to the content of a digital asset 141 (e.g., applying the hashing function to the text content of a social media post). The hash of the digital asset 141 may also be referred to as a hash value.

In one embodiment, the asset verification component 110 may update the ledger 131 (e.g., a distributed ledger) of the blockchain system 120 with a hash of a digital asset 141 to establish and/or verify the provenance of the digital asset 141. For example, the system architecture 100 may provide for non-repudiation of a digital asset 141, as discussed in more detail below. The asset verification component 110 also provides attribution of a digital asset 141 to one or more users. The asset verification component 110 further provides for content integrity, as discussed in more detail below. All of these functions, operations, methods, actions, etc., allow the asset verification component to establish and/or verify the provenance of the digital asset 141.

In one embodiment, the asset verification component 110 may update the ledger 131 by adding an entry or a block to the ledger 131. For example, the asset verification component 110 may create an entry (or block) and may provide the entry to a node 130. The entry may include the hash of the digital asset 141. The node 130 may write the entry to the ledger 131 and may instruct and/or cause the other nodes 130 in the blockchain system 120 to update their respective copies of the ledger 131 to include the newly added entry.

An entry in the ledger 131 may include various other information and/or data that may be used to help establish the provenance of a digital asset 141. In one embodiment, the entry may include a resource identifier that identifies the digital asset 141 and/or indicates a location from which the digital asset 141 may be accessed. Examples of a resource identifier may include a uniform resource locator (URL), a uniform resource name (URN), a uniform resource identifier (URI), etc. As discussed above, the system architecture 100 may include multiple versions of a digital asset 141. Each version of the digital asset 141 may have and/or may be associated with a different resource identifier. For example, a first version of the digital asset 141 may have the resource identifier document-v1 and a second version of the digital asset 141 may have the resource identifier document-v2.

In another embodiment, the entry may include a set of identifiers (e.g., one or more identifiers) for a set of users (e.g., one or more users) who signed the digital asset 141. As discussed above, the digital asset 141 may include one or more signatures (e.g., electronic signatures) from one or more users. The entry may include identifiers (e.g., a user name, an anonymized identifier, an alphanumeric value, an email address, etc.) that may be used to identify the one or more users who signed the digital asset 141.

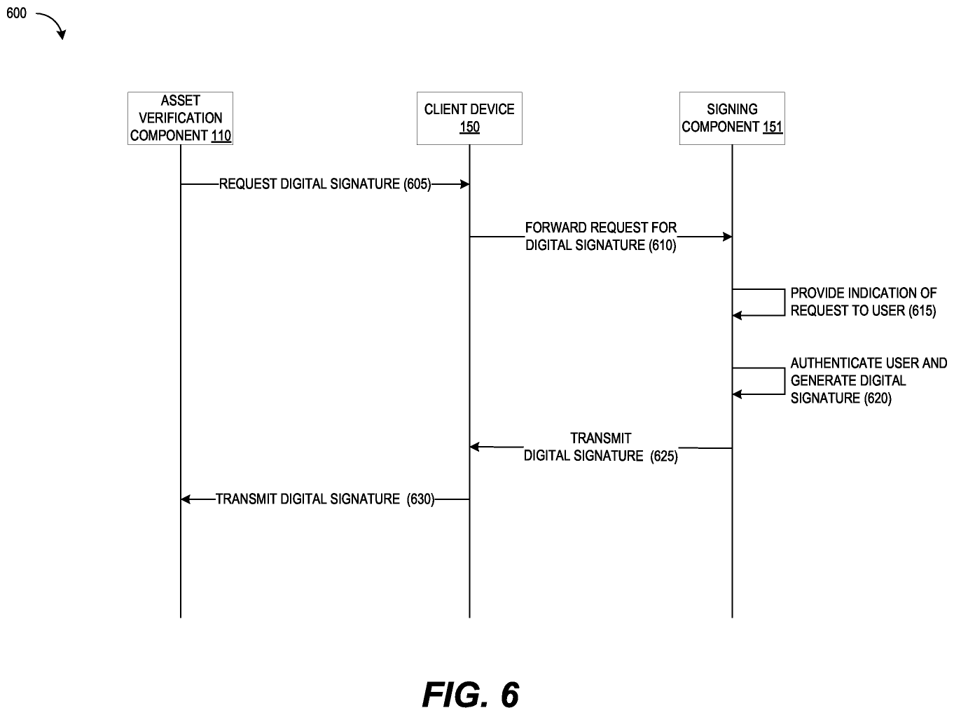

In one embodiment, an entry in the ledger may include a set of signatures that are associated with a digital asset 141. The set of signatures may be different than one or more other signatures (e.g., electronic signatures) that may be included in the digital asset 141. The set of signatures may be digital signatures that are generated based on private keys of one or more users, and based on the hash of the digital asset 141. For example, a user may generate a digital signature for a hash of the digital asset 141 using a private key of the user. The set of signatures that are associated with the digital asset 141 may be referred to as digital signatures. Generating the digital signatures for the hash of the digital asset 141 is discussed in more detail below. In one embodiment, one or more of the client devices 150 may include a signing component (e.g., a hardware or software token, an app on a smartphone/tablet computer, etc.). The signing component (e.g., signing component 151 illustrated in FIG. 6) may allow a user and/or a client device to generate a digital signature for and/or associated with a digital asset 141, as discussed in more detail below.

In one embodiment, the asset verification component 110 may receive a request from a client device 150 to verify the provenance of a digital asset 141. For example, the asset verification component 110 may receive a message (or other data) requesting the asset verification component 110 to verify the authorship of the digital asset 141, the version of the digital asset 141, the content of the digital asset 141, etc. The message or request (to verify the provenance of the digital asset 141) may include an identifier (e.g., a resource identifier, a storage location, a URL, etc.) for the digital asset 141. The asset verification component 110 may retrieve a hash of the digital asset from the ledger 131 based on the identifier. For example, the asset verification component 110 may analyze the entries (e.g., blocks) in the ledger 131 to identify an entry that includes the identifier for the digital asset 141. The asset verification component 110 may retrieve the hash of the digital asset 141 from the entry.

In one embodiment, the asset verification component 110 may provide the hash of the digital asset to the client device 150 that sent the request to verify the provenance of the digital asset 141. This may allow the client device 150 to compare the hash received from the asset verification component 110 with a hash generated by the client device 150. For example, the client device 150 may obtain (e.g., download, retrieve from a storage location, etc.) a copy of the digital asset 141 and may generate a hash of the digital asset 141. The client device 150 may compare the hash received from the asset verification component 110 with the has that was generated by the client device 150. If the hashes match, the client device 150 may determine that the digital asset 141 (e.g., the content of the digital asset 141) has been verified (e.g., has not been tampered with, altered, modified, etc.).

In another embodiment, the asset verification component 110 may receive a hash of the digital asset 141 from the client device 150 that sent the request to verify the provenance of the digital asset 141. The asset verification component 110 may compare the hash received in the request with the hash in the entry in the ledger 131. If the hashes match, the asset verification component 110 may determine that the digital asset 141 has been verified. The asset verification component 110 may transmit a message and/or other data to the client device 150 indicating whether the provenance of the digital asset 141 has been verified.

In a further embodiment, the asset verification component 110 may obtain the digital asset 141 based on the request (from the client device 150) to establish the provenance of the digital asset 141. For example, the request may include a resource identifier for the digital asset 141 (e.g., a storage location, a URL), and the asset verification component 110 may retrieve the digital asset 141 based on the resource identifier. In another example, the request may include a copy of the digital asset. The asset verification component 110 may generate a hash based on the digital asset 141 and may compare the generated hash with the hash in the entry in the ledger 131. If the hashes match, the asset verification component 110 may determine that the digital asset 141 has been verified. The asset verification component 110 may transmit a message and/or other data to the client device 150 indicating whether the provenance of the digital asset 141 has been verified.

In one embodiment, the asset verification component 110 may also check one or more digital signatures associated with a digital asset 141, to verify the provenance of the digital asset 141. For example, digital signatures may be generated by users who sign a digital asset, as discussed in more detail below. The asset verification component 110 may verify that a digital signature was generated by a particular user for a particular digital asset 141 when requested to provide such verification. This may allow other users to verify that a digital asset 141 (e.g., a legal document) was signed by a particular user.

In one embodiment, the asset verification component 110 may receive a request to establish the provenance of the provenance of another version of a digital asset 141. Because the other version of a digital asset 141 may be treated by the asset verification component 110 as a separate or new digital asset, the asset verification component 110 may perform the same operations, actions, functions, methods, etc., described herein with respect to establishing the provenance of the second version of the digital asset 141. For example, the asset verification component 110 may generate a hash of the other version of the digital asset 141 and may update the ledger 131 with the hash (of the other version of the digital asset 141) to establish the provenance of the other version of the digital asset 141.

Although one blockchain system (e.g., blockchain system 120) is illustrated in FIG. 1, the system architecture 100 may include multiple blockchain systems in other embodiments. For example, the system architecture 100 may include a second blockchain system that includes a second set of nodes. Each node of the second set of nodes may store a second ledger (e.g., a second distributed ledger). The asset verification component 110 may update the second ledger with the hash of a digital asset 141 to establish the provenance of the digital asset 141. As discussed above, the distributed nature of a ledger allows for more security against loss, more security against hacking, etc. Using multiple blockchain systems (which have multiple ledgers) may further protect the data indicating the provenance of digital assets against loss, against hackers or malicious users, etc.

In one embodiment, the asset verification component 110 may use one or more profiles or accounts to access the blockchain system 120 (e.g., to write records and/or blocks into the ledger 131). The profiles or accounts that are used to access the blockchain system 120 may be referred to as wallets. For example, the asset verification component 110 may use its own wallet to access the ledger 131. Thus, the users of the asset verification component 110 may not obtain wallets (e.g., accounts) for the blockchain system 120. When the users of the asset verification component 110 create and/or update a digital asset, the asset verification component 110 may use a wallet (e.g., an account or profile) associated with the asset verification component 110 to write the hash of the digital asset, signatures, and/or the public keys, to the ledger 131. This may reduce the complexity for users of the asset verification component 110 120 as they do not have to obtain accounts, profiles, wallets, etc., for the blockchain system 120 when establishing and/or verifying the provenance of digital assets 141. For example, a user may not need to obtain a wallet to create, store, update, etc., a digital asset 141. Instead, the user may communicate with the asset verification component 110 (e.g., may send requests and/or messages to the asset verification component 110) and the asset verification component 110 may use a wallet (e.g., an account, profile, etc.) associated with the asset verification component 110 to access the blockchain system.

The asset verification component 110 may also encrypt one or more of the digital assets 141 to help protect the digital assets 141 in case the data storage system 140 is comprised. For example, the digital assets 141 may be encrypted using a private/secret key. Thus, even if an unauthorized user accesses the data storage system 140, the unauthorized user would be unable to decrypt the digital assets 141 and would be unable to view the content of the digital assets 141.

The asset verification component 110 may record the access history of one or more digital assets 141. For example, the asset verification component 110 may record or log each time a digital asset 141 is created, viewed/accessed, modified, etc. The record or log may be stored in the ledger 131 to allow other uses to access the record or log. The record or log may also be kept private by the asset verification component 110.

The asset verification component 110 may also allow one digital asset 141 to link to another digital asset 141. For example, a new article (e.g., a first digital asset 141) may cite another news article (e.g., a second digital asset 141). In one embodiment, the digital assets 141 that are stored in the data storage system may be immutable (e.g., may not be changed) once they are created. However, the digital assets 141 may be updated and new versions may be created. Each new version may also be immutable. Thus, new versions of the digital asset 141 are created each time a user wants to modify a digital asset 141. This may allow the asset verification component 110 to track the different versions/iterations of a digital asset 141 and may also allow the asset verification component 110 to establish the identity of the users who have created and/or edited the different versions of the digital asset 141.

The asset verification component 110 may also allow one digital asset 141 to link to another digital asset 141. For example, a new article (e.g., a first digital asset 141) may cite another news article (e.g., a second digital asset 141). In one embodiment, the digital assets 141 that are stored in the data storage system may be immutable (e.g., may not be changed) once they are created. However, the digital assets 141 may be updated and new versions may be created. Each new version may also be immutable. Thus, new versions of the digital asset 141 are created each time a user wants to modify a digital asset 141. This may allow the asset verification component 110 to track the different versions/iterations of a digital asset 141 and may also allow the asset verification component 110 to establish the identity of the users who have created and/or edited the different versions of the document.

In some embodiments, the system architecture 100 may provide for verification of the provenance of digital assets 141. For example, the system architecture 100 may provide for non-repudiation of a digital asset 141. Once a user publishes and digitally signs a digital asset 141, the user is unable to deny that publication because the hash of the digital asset 141 and their public key are stored in the ledger 131. The system architecture 100 also provides attribution. For example, the digital signature of the digital asset 141 may be used to establish proof of the identity of the user who created and/or modified a digital asset 141.

In some embodiments, the system architecture 100 also provides for content integrity. The digital signature and/or hash may be used to verify the integrity of the digital asset 141. This may help ensure that a digital asset is unchanged from the original published version. In some embodiments, the system architecture 100 leverages the distributed scale and transparency of the blockchain system 120 (e.g., of the ledger 131) to help ensure that the integrity and verification of the digital assets 141 cannot be compromised.

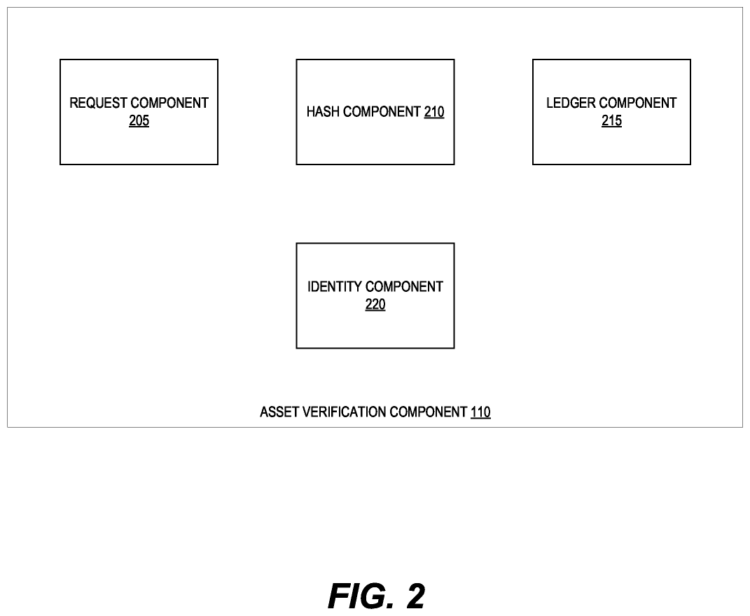

FIG. 2 is a block diagram that illustrates an example asset verification component 110, in accordance with some embodiments of the present disclosure. The asset verification component 110 includes, but is not limited to, a request component 205, a hash component 210, a ledger component 215, and an identity component 220. Some or all of components 205-220 may be implemented in software, hardware, or a combination thereof. For example, one or more of components 205-220 may be installed in persistent storage device, loaded into memory, and executed by one or more processors (not shown). In another example, one or more of components 205-220 may be processing devices, such as an application specific integrated circuit (ASIC), a field programmable gate array (FPGA), etc. Some of components 205-220 may be integrated together as an integrated component. In addition, some of components 205-220 may be located in difference computing devices (e.g., different server computers).

In one embodiment, the request component 205 may process requests that are received by the asset verification component 110. For example, the request component 205 may process requests to establish and/or verify the provenance of a digital asset. The request component 205 may also transmit requests to computing devices. For example, the request component 205 may transmit a request to a client device to request an electronic signature or to request a digital signature for a hash.

In one embodiment, the hash component 210 may generate and/or compare hashes of digital assets. For example, the hash component 210 may generate the hash for a digital asset. In another example, the hash component 210 may compare a hash in a ledger with a hash that was generated for a digital asset. In one embodiment, the ledger component 215 may update the ledger of a blockchain system to establish the provenance of a digital asset. For example, the ledger component 215 may update a ledger to include the hash of a digital asset. The ledger component 215 may also be used to access the ledger of the blockchain system.

In one embodiment, the identity component 220 may be used to verify the identity of a user of the asset verification component 110. For example, a user may create an account or profile with the asset verification component 110. This may allow the user to establish the provenance of digital assets or request verification of the provenance of digital assets. The identity component 220 may be used to verify the identity of the user based on documents and/or information provided by a user. For example, the identity component 220 may request copies of a user's passport, birth certificate, driver's license, military identification, social security number, etc., to verify a user's identity. The identity component 220 may also request that a user provide previous home address, previous places of employment, information about bank accounts, credit, cards, etc., in order to verify the identity of a user. The users may provide strongly established, attestable proof of identity that may be verified by the identity component 220. The proof of identity may be similar to the proof of identity used to obtaining a passport, a bank loan, etc. In some embodiments, the identity component 220 may interface with other existing systems that may perform the verification of the user's identity and may provide the identity component 220 with the result of the verification.

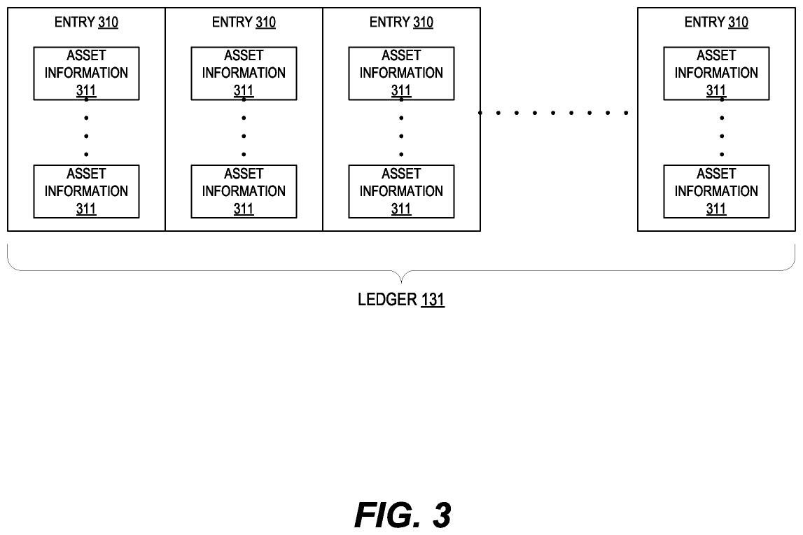

FIG. 3 is a block diagram that illustrates an example ledger 131, in accordance with some embodiments of the present disclosure. The ledger 131 may also be referred to as a distributed ledger. Copies of the ledger 131 may be stored on nodes of a blockchain system. For example, each node 130 of a blockchain system 120 (illustrated in FIG. 0.1) may store a copy of the ledger 131, as discussed above.

As discussed above, an asset verification component 110 may establish the provenance of digital assets and/or may verify the provenance of digital assets using the ledger 131. The ledger 131 includes multiple entries 310. Each entry includes one or more asset information 311. For example, an entry 310 may include asset information 311 for one digital asset. In another example, an entry 310 may include multiple asset information 311 for multiple digital assets. The asset information 311 may also be referred to as provenance information, provenance data, etc.

The asset information 311 may be data that is used to establish and/or verify the provenance of a digital asset. For example, the asset information 311 may include a hash of a digital asset. In another example, the asset information 311 may include signed hashes, as discussed in more detail below. In a further example, the asset information 311 may include user identifiers of users who signed the digital asset. In yet another example, the asset information 311 may include the public keys or digital certificates which may be used to verify electronic signatures and/or digital signatures.

As discussed above, the ledger 131 may be part of a blockchain system for a cryptocurrency. In one embodiment, an asset verification component (e.g., asset verification component 110 illustrated in FIG. 1) may perform one or more transactions using the cryptocurrency to access the ledger 131. For example, performing a transaction using the cryptocurrency (e.g., buying or selling the cryptocurrency) may allow the asset verification component to update the ledger 131 with a record of the transaction. The asset information 311 may be included in the record of the transaction. As discussed above, the asset verification component may have a profile, account, or wallet that may be used to access the blockchain system and the ledger 131.

The digital signatures, hashes of digital assets, and/or public keys of users who create/modify digital assets may be stored in the asset information 311 of the ledger 131. Although the digital signatures and public keys may be stored in the ledger 131, the identity of the users may not be determined or ascertained from the public keys. For example, the public key may not include any identifier information (e.g., private information) that may be used to identify the user associated with the public key.

In one embodiment, the asset verification component may also encrypt some or all of the asset information 311. For example, one or more of the digital signatures, hashes, and/or public keys that are stored in the blocks of the ledger 131. This may provide additional security for the digital signatures, hashes, and/or public keys and may prevent malicious users from viewing the digital signatures, hashes, and/or public keys.

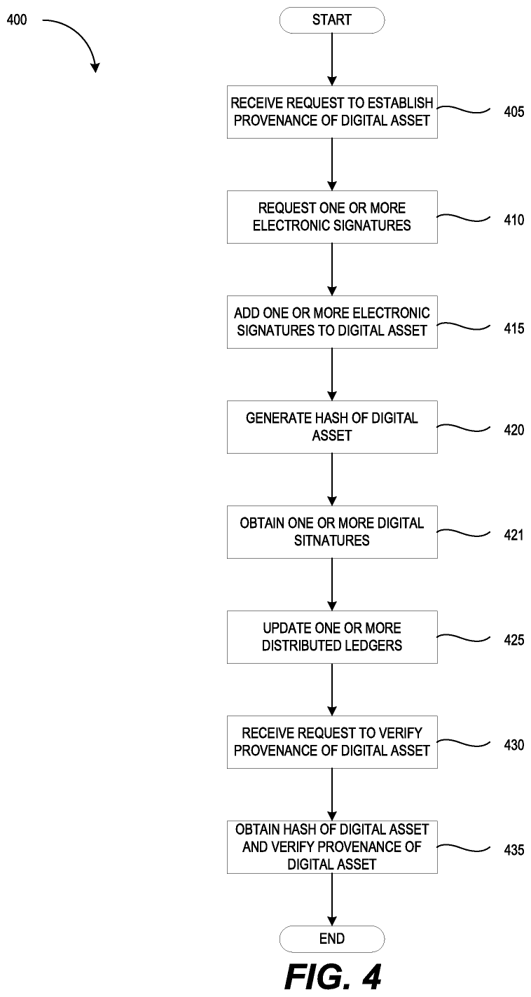

FIG. 4 is a flow diagram of a method 400 of establishing the provenance of a digital asset, in accordance with some embodiments. Method 400 may be performed by processing logic that may comprise hardware (e.g., circuitry, dedicated logic, programmable logic, a field programmable gate array (FPGA), an application specific integrated circuit (ASIC), a processor, a processing device, a central processing unit (CPU), a system-on-chip (SoC), etc.), software (e.g., instructions running/executing on a processing device), firmware (e.g., microcode), or a combination thereof. In some embodiments, the method 400 may be performed by an asset verification component (e.g., asset verification component 110 illustrated in FIG. 1) and/or one or more computing devices.

The method 400 starts at block 405 where the method 400 receives a request to establishing the provenance of the digital asset. For example, the method 400 may receive the digital asset along with or separate from the request to establishing the provenance of the digital asset. The request to establishing the provenance of the digital asset may also indicate one or more users that should sign the digital asset. At block 410, the method 400 may request one or more electronic signatures from the one or more users, as discussed above. At block 415, the method 400 may receive the electronic signatures from the one or more users and may add (e.g., append) the electronic signatures to the digital asset. In some embodiments, blocks 410 and 415 may be optional. For example, electronic signatures (e.g., an image of a user's signature) may not be used for and/or may not be added to a digital asset.

At block 420, the method 400 may generate a hash of the digital asset (e.g., the signed digital asset). For example, the method 400 may generate the hash using a cryptographic hash function, as discussed above. The method 400 may also optionally request that that hash of the digital asset be signed by the one or more users, as discussed above. At block 421, the method 400 may obtain one or more digital signatures for and/or associated with the digital asset. For example, the method 400 may transmit one or more messages to one or more client devices to request digital signatures for a hash of the digital asset or for the digital asset. Each of the client devices may generate a digital signature for the hash of the digital asset (or for the digital asset). The method 400 may receive the digital signatures from the client devices at block 421. At block 425, the method 400 may update one or more ledgers (e.g., distributed ledgers) of one or more blockchain systems with the hash of the digital asset. For example, the method 400 may add an entry into the ledger that includes the hash and/or other information that may be used to establishing the provenance of the digital asset (e.g., public keys, digital certificates, user identifiers, signed hashes, digital signatures, etc.).

A block 430, the method 400 may receive a request to verify the provenance of a digital asset. For example, a user may request to verify that a digital asset has not been modified and that the digital asset was approved by a particular user. The method 400 may obtain a hash of the digital asset from the ledger and may verify the provenance of the digital asset based on the hash. For example, the method 400 may generate a second hash based on a copy of the digital asset and may compare the hash with the second hash, as discussed above. In another example, the method 400 may provide the hash to a client device and the client device may compare the hash with a second hash of the digital asset, as discussed above.

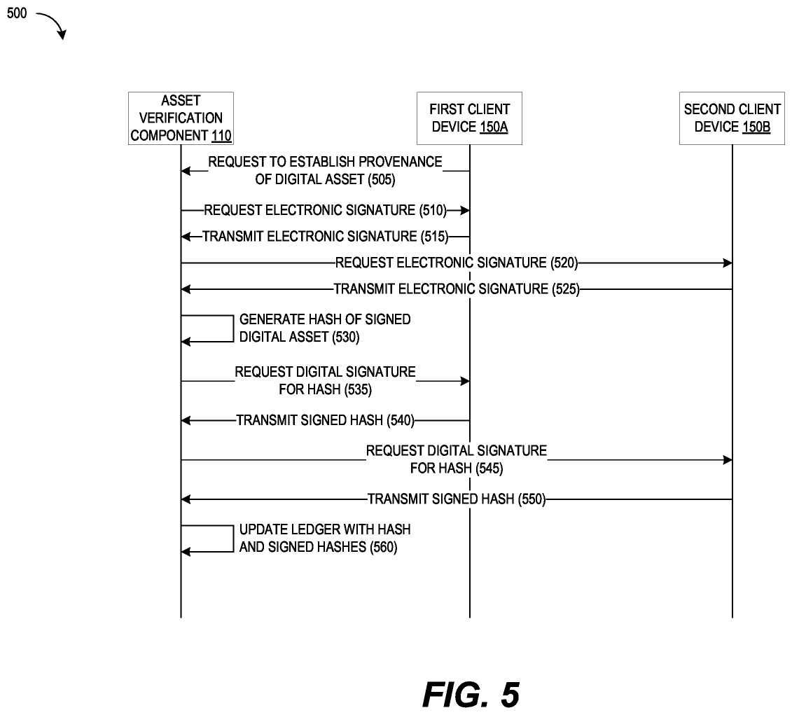

FIG. 5 is a sequence diagram 500 illustrating example actions for signing a digital asset, in accordance with one or more embodiments of the present disclosure. The actions (e.g., operations, functions, processes, procedures, etc.) may be performed by an asset verification component 110, a first client device 150A, and a second client device 150B. The actions illustrated in the sequence diagram 500 may be performed as part of a signing process for a digital asset (e.g., may be performed when one or more users request to sign and establish the provenance of a digital asset). The signing process may include two users of the client devices 150A and 150B (e.g., two separate users who are both adding their electronic signatures to a digital asset and establishing the provenance of the digital asset).

In one embodiment, the signing process may begin at block 505 when the asset verification component 110 receives a request obtain signatures for a digital asset from a first client device 150. For example, the first client device 150A may transmit a request (e.g., a message or other data) to the asset verification component 110 to request that the asset verification component 110 establish the provenance of the digital asset. In one embodiment, the request may also indicate which users should sign the digital asset. For example, the request may include user identifiers (e.g., email addresses, user names, etc.) for users that should sign the digital asset. In another example, the request may include identifiers for client devices (e.g., a device name, an internet protocol (IP) address, a medium access control (MAC) address, etc.) of the users that should sign the digital asset. In one embodiment, the request may also include the digital asset that is to be signed. For example, the first client device 150A may transmit the digital asset to the asset verification component 110 in the request to obtain signatures for the digital asset. In some embodiments, the signing process may be part of a process to establish the provenance of a digital asset. For example, the signing process (illustrated in FIG. 5) may be part a process to provide proof that the content of a digital asset is valid or approved by the users who will sign the digital asset.

At block 510, the asset verification component 110 may request an electronic signature from the first client device 150A. For example, the asset verification component 110 may transmit the digital asset to the first client device 150A and may request that the first client device (e.g., a first user) add an electronic signature to the digital asset. In another example, the asset verification component 110 may transmit a request for the electronic signature without transmitting the digital asset. At block 515, the first client device 150A (e.g., a first user) may provide an electronic signature to the asset verification component 110. For example, the first client device 150A may transmit the digital asset with the electronic signature of a first user included in the digital asset (e.g., added to, appended to, etc.). In another example, the first client device 150 may transmit the electronic signature of the first user to the asset verification component 110 without transmitting the digital asset.

At block 520, the asset verification component 110 may request an electronic signature from the first client device 150B. For example, the asset verification component 110 may transmit the digital asset to the second client device 150B and may request that the second client device (e.g., a second user) add an electronic signature to the digital asset. In another example, the asset verification component 110 may transmit a request for the electronic signature without transmitting the digital asset. At block 525, the second client device 150B (e.g., a first user) may provide an electronic signature to the asset verification component 110. For example, the second client device 150B may transmit the digital asset with the electronic signature of a second user included in the digital asset (e.g., added to, appended to, etc.). In another example, the second client device 150B may transmit the electronic signature of the second user to the asset verification component 110 without transmitting the digital asset.

At block 530, the asset verification component 110 may generate a hash of the signed digital asset, which may include the two digital signatures from the first client device 150A and the second client device 150B. For example, the asset verification component 110 may generate a hash of the signed digital asset (e.g., a hash value) using a cryptographic hashing function.

At block 535, the asset verification component 110 may transmit a request for the first client device 150A (e.g., the first user) to digitally sign the hash (of the signed digital asset). For example, the asset verification component 110 may transmit a request for the first client device 150A to generate a digital signature of the hash. At block 540, the first client device 150 may generate the digital signature for the hash and may transmit the signed hash to the asset verification component 110. For example, the first client device 150A may generate a digital signature for the hash using a first private key of the first user and may append the signature to the hash.

At block 545, the asset verification component 110 may transmit a request for the second client device 150B (e.g., the second user) to digitally sign the hash (of the signed digital asset). For example, the asset verification component 110 may transmit a request for the second client device 150B to generate a digital signature of the hash. At block 550, the second client device 150 may generate the digital signature for the hash and may transmit the signed hash to the asset verification component 110. For example, the second client device 150B may generate a digital signature for the hash using a second private key of the second user and may append the signature to the hash.

At block 560, the asset verification component 110 may update a ledger of a blockchain system with the hash of the signed digital asset (which includes the electronic signatures of the first user and the second user) and the signed hashes. This allows the asset verification component 110 to establish the provenance of the digital asset. For example, recording the hash of the signed digital asset allows other users to verify that the content the digital asset (or a copy of the digital asset) has not been altered, modified etc. This may allow other users to verify that they have the correct version of a digital asset. In another example, signed hashes (e.g., hashes with digital signatures) may allow other users to verify that the first user and the second user signed the digital asset. This may allow the users to trust that the content of the digital asset has been generated, approved of, or agreed to by the first user and the second user.

The signing process illustrated in FIG. 5 may be used for various purposes. For example, the signing process illustrated in FIG. 5 may allow the asset verification component 110 to establishing the provenance of legal documents (e.g., contracts, title to land/property, etc.) that have been signed by different users. In another example, the signing process in FIG. 5 may allow the asset verification component 110 to establish the provenance of an article, press release, and/or other content that has been authored and/or approved by different users.

Although two client device are illustrated in FIG. 5, more client devices (and thus more users and/or more signatures) may be part of the signing process in other embodiments. For example, blocks 520, 525, 545, and 550 may be repeated for additional client devices. In some embodiments, the signing process illustrated in FIG. 5 may not include electronic signatures (e.g., text, an image of a user's signature, etc.). For example, the client devices 150A and 150B may generate digital signatures (e.g., the digital signatures for the hash of the digital asset) and that digital asset may not include electronic signatures. Thus, blocks 510, 515, 520, and 525 may be optional.

FIG. 6 is a sequence diagram 600 illustrating example actions for signing a digital asset, in accordance with one or more embodiments of the present disclosure. The actions (e.g., operations, functions, processes, procedures, etc.) may be performed by an asset verification component 110, a client device 150, and signing component 151. The actions illustrated in the sequence diagram 600 may be performed when a user of the client device 150 signs a digital asset. This actions illustrated in the sequent diagram 600 may also be performed when the user associates a digital signature with a digital asset (e.g., generates a digital signature for the digital asset or for a hash of the digital asset). As discussed above, the digital asset may optionally include one or more electronic signatures (e.g., text, an image of a user's handwritten signature, etc.).

In one embodiment, the signing process may begin at block 605 when the asset verification component 110 transmit a request for a digital signature for and/or associated with a digital asset to a client device 150. In some embodiments, the signing process may be part of a process to establish the provenance of a digital asset. For example, the signing process (illustrated in FIG. 5) may be part a process to provide proof that the content of a digital asset is valid or approved by the user of the client device 150 who will sign the digital asset and/or sign a hash of the digital asset. In some embodiments, the request for the digital signature may be transmitted to the client device 150 via a message, such as a short message service (SMS) message, an email message, a chat message, etc. In other embodiments, the request for the digital signature may be transmitted to the client device via a secure communication channel (e.g., an encrypted communication channel, such as a secure shell (SSH) tunnel, a transport layer security (TLS) communication channel, etc.).

At block 610, the client device 150 may forward the request for the digital signature (which will be for and/or associated with the digital asset) to a signing component 151. In one embodiment, the signing component 151 may be located on a different client device than client device 150. For example, a user may be viewing a digital asset using a web browser or a media viewer application on a laptop computer (e.g., client device 150). The signing component 151 may be a software token (e.g., an application, an app, etc.) that is located on a user's smartphone (e.g., another computing device). If the signing component 151 is located on a different client device, the client device 150 may also use a secure communication channel between the different client device and the client device 150 to forward the request. In another embodiment, the signing component 151 may be located on the client device 150. For example, the client device 150 may be a smartphone that includes both a media viewing application (which is used by the user to view the digital asset) and the signing component 151. In some embodiments, the signing component 151 may be a hardware token (e.g., a separate device) that is used to generate digital signatures.

At block 615, the signing component 151 may provide an indication of the request to sign the digital asset to the user. For example, the signing component 151 may display a user interface, a message, an alert, etc., to a user. The indication of the request may include information about the digital asset. For example, the indication may include a hash of the digital asset, a name of the digital asset, an identifier for the digital asset, an identifier of the client device 150, identifiers for other users who may also be signing and/or generating signatures for the digital asset, etc. At block 620, the signing component 151 authenticate the user. For example, the signing component 151 may request and/or verify one or more credentials from a user (e.g., a username, password, etc.). In another example, the signing component 151 may request and/or verify one or more biometric credentials (e.g., a fingerprint, a retina scan, etc.) using biometric sensors (e.g., a fingerprint reader) on the client device where the signing component 151 is located. If the user is authenticated, the signing component 151 may generate the digital signature using a private key of the user. For example, the signing component 151 may generate a digital signature for a hash of the digital asset and/or may generate a digital signature for the digital asset. The digital signature is associated with the digital asset. The private key of the user may be stored in a secure memory on the client device where the signing component 151 is located. For example, the private key of the user may be stored in an encrypted memory device or an encrypted portion of a memory. The secure memory may be inaccessible to other devices, applications, processes, services, etc.

At block 625, the signing component 151 may optionally transmit the digital signature to the client device 150. For example, if the signing component 151 is located on a client device (e.g., if the signing component is on a user's smartphone) that is separate from the client device 150, the signing component 151 may transmit the digital signature to the client device 150 so that the client device 150 transmit the digital signature to the asset verification component 110. At block 630, the client device 150 may transmit the digital signature to the asset verification component 110. As discussed above, one or more secure communication channels may be used to communicate (e.g., transmit, forward, etc.) the digital signature between the signing component 151, the client device 150, and the asset verification component 110.

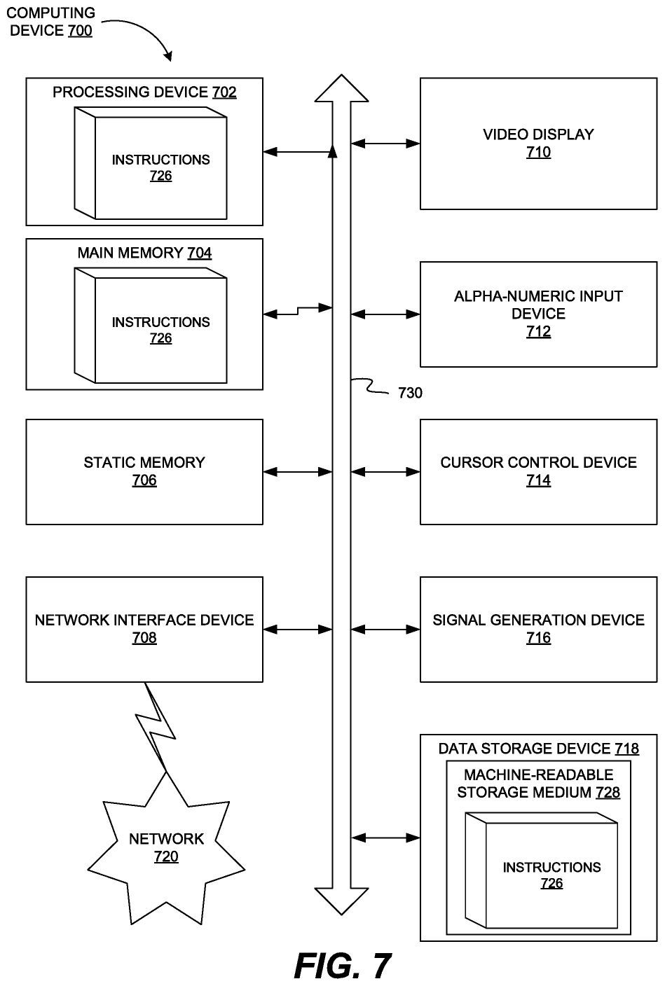

FIG. 7 is a block diagram of an example computing device 700 that may perform one or more of the operations described herein, in accordance with some embodiments. Computing device 700 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 700 may include a processing device (e.g., a general purpose processor, a PLD, etc.) 702, a main memory 704 (e.g., synchronous dynamic random access memory (DRAM), read-only memory (ROM)), a static memory 706 (e.g., flash memory and a data storage device 718), which may communicate with each other via a bus 730.

Processing device 702 may be provided by one or more general-purpose processing devices such as a microprocessor, central processing unit, or the like. In an illustrative example, processing device 702 may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 702 may also comprise one or more special-purpose processing devices such as an application specific integrated circuit (ASIC), a field programmable gate array (FPGA), a digital signal processor (DSP), network processor, or the like. The processing device 702 may be configured to execute the operations described herein, in accordance with one or more aspects of the present disclosure, for performing the operations and steps discussed herein.

Computing device 700 may further include a network interface device 708 which may communicate with a network 720. The computing device 700 also may include a video display unit 710 (e.g., a liquid crystal display (LCD) or a cathode ray tube (CRT)), an alphanumeric input device 712 (e.g., a keyboard), a cursor control device 714 (e.g., a mouse) and an acoustic signal generation device 716 (e.g., a speaker). In one embodiment, video display unit 710, alphanumeric input device 712, and cursor control device 714 may be combined into a single component or device (e.g., an LCD touch screen).

Data storage device 718 may include a computer-readable storage medium 728 on which may be stored one or more sets of instructions, e.g., instructions for carrying out the operations described herein, in accordance with one or more aspects of the present disclosure. Instructions 726 implementing nodes and/or asset verification components may also reside, completely or at least partially, within main memory 704 and/or within processing device 702 during execution thereof by computing device 700, main memory 704 and processing device 702 also constituting computer-readable media. The instructions may further be transmitted or received over a network 720 via network interface device 708.

While computer-readable storage medium 728 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Unless specifically stated otherwise, terms such as “receiving,” “generating,” “updating,” “adding,” “retrieving,” “providing,” “performing,” “transmitting,” “storing,” “sending,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method, comprising:
receiving a request to establish a provenance of a digital asset, wherein the digital asset is associated with a set of signatures;
generating a hash of the digital asset; and
updating a distributed ledger of a blockchain system with the hash of the digital asset to establish the provenance of the digital asset.

2. The method of claim 1, wherein updating the distributed ledger of the blockchain system comprises:
adding an entry to the distributed ledger of the blockchain system, wherein the entry comprises the hash of the digital asset.

3. The method of claim 2, wherein:
the entry further comprises a resource identifier for the digital asset;
the resource identifier indicates a location from which the digital asset may be accessed.

4. The method of claim 2, wherein the entry further comprises a set of identifiers for a set of users associated with the set of signatures.

5. The method of claim 2, wherein:
the entry further comprises the set of signatures;
each signature of the second set of signatures is generated based on the hash of the digital asset and a private key associated with a user.

6. The method of claim 1, wherein the hash is generated for a version of the digital asset.

7. The method of claim 1, further comprising:
receiving, from a client device, a second request to verify the provenance of the digital asset;
retrieving the hash of the digital asset from the distributed ledger of the blockchain system; and
providing the hash of the digital asset to the client device.

8. The method of claim 1, further comprising:
receiving, from a client device, a second request to verify the provenance of the digital asset, wherein the request comprises a second hash;
retrieving the hash of the digital asset from the distributed ledger of the blockchain system;
performing a comparison of the hash of the of the digital asset with the second hash; and
providing, to the client device, an indication of whether the provenance of the digital asset has been verified, based on the comparison.

9. The method of claim 1, further comprising:
receiving a second request to establish a second provenance of a second version of the digital asset, wherein the digital asset comprises a second set of digital signatures;
generating a second hash of the second version of the digital asset; and
updating the distributed ledger of the blockchain system with the second hash of the second version of the digital asset to establish the second provenance of the second version of the digital asset.

10. The method of claim 1, further comprising:
receiving the digital asset; and
storing the digital asset in one or more of the distributed ledger of the blockchain system and a data store that is separate from the blockchain system.

11. The method of claim 1, further comprising:
updating a second distributed ledger of a second blockchain system with the hash of the digital asset to establish the provenance of the digital asset.

12. The method of claim 1, wherein:
the blockchain system is associated with a cryptocurrency; and
one or more transactions of the cryptocurrency are stored in the distributed ledger of the blockchain system.

13. The method of claim 1, further comprising:
sending a second request to sign the digital asset to a client device; and
receiving, from the client device, a signature; and
adding the signature to the digital asset.

14. An apparatus, comprising:
a memory configured to store data; and
a processing device coupled to the memory, the processing device to:
receive a request to establish a provenance of a digital asset, wherein the digital asset is associated with a set of signatures;
generate a hash of the digital asset; and
update a distributed ledger of a blockchain system with the hash of the digital asset to establish the provenance of the digital asset.

15. The apparatus of claim 14, wherein to update the distributed ledger of the blockchain system the processing device is further to:
add an entry to the distributed ledger of the blockchain system, wherein the entry comprises the hash of the digital asset.

16. The apparatus of claim 15, wherein:
the entry further comprises one or more of a resource identifier for the digital asset and a set of identifiers for a set of users associated with the set of signatures; and
the resource identifier indicates a location from which the digital asset may be accessed.

17. The apparatus of claim 15, wherein:
the entry further comprises the set of signatures;
each signature of the set of signatures is generated based on the hash of the digital asset and a private key associated with a user.

18. The apparatus of claim 14, wherein the processing device is further to:
receive, from a client device, a second request to verify the provenance of the digital asset;
retrieve the hash of the digital asset from the distributed ledger of the blockchain system; and
provide the hash of the digital asset to the client device.

19. The apparatus of claim 14, wherein the processing device is further to:
receive, from a client device, a second request to verify the provenance of the digital asset, wherein the request comprises a second hash;
retrieve the hash of the digital asset from the distributed ledger of the blockchain system;
perform a comparison of the hash of the of the digital asset with the second hash; and
provide, to the client device, an indication of whether the provenance of the digital asset has been verified, based on the comparison.

20. A non-transitory machine-readable medium having instructions stored therein, which when executed by a processing device, cause the processing device to perform operations, the operations comprising:
receiving a request to establish a provenance of a digital asset, wherein the digital asset is associated with a set of signatures;
generating a hash of the digital asset; and
updating a distributed ledger of a blockchain system with the hash of the digital asset to establish the provenance of the digital asset.
